(19) United States
(12) Patent Application Publication
(10) Pub. No.: US 2015/0103850 A1
(43) Pub. Date: Apr. 16, 2015

(54) Communication Device Utilizing An Interrupting Alignment Pattern

(71) Applicant: Avago Technologies General IP (Singapore) Pte. Ltd., Singapore (SG)

(72) Inventors: Xiaozhong Wang, Cupertino, CA (US); David Chak Wang Hui, Santa Clara, CA (US)

(73) Assignee: Avago Technologies General IP (Singapore) Pte. Ltd., Singapore (SG)

(21) Appl. No.: 14/050,930

(22) Filed: Oct. 10, 2013

(51) Int. Cl. H04J 3/22

(52) U.S. Cl. CPC H04J 3/22
USPC 370/538

(57) ABSTRACT

A communication device utilizing an interrupting alignment pattern is disclosed. The communication device may comprise a plurality of inputs, a pattern generator, a multiplexer, a control circuit, an interrupt circuit, and an output. The pattern generator may be configured to generate an alignment pattern. The control circuit may be configured to control the multiplexer to multiplex a plurality of incoming data streams into a serialized output data stream. The interrupt circuit may be configured to interrupt the serialized output data stream with the alignment pattern. The output may be configured to output the alignment pattern in place of the serialized output data stream, when the serialized output data stream is interrupted by the alignment pattern.

### BACKGROUND

The demand for high-speed communication is increasingly higher. Video on demand, high definition television, and video conferencing are some of the examples of applications that drive the demand for high-speed communication system.

Increasing adoption of cloud computing by businesses further intensifies the need for the communication system to expand its bandwidth capacity. This demand pushes for a greater adoption for optical fiber networks not only for longer distance applications, but for other applications that are traditionally performed by copper based communication networks.

In optical fiber networks, copper based networks or other communication networks, multiplexing is one of the methods utilized to obtain a higher data rate by serializing several parallel data streams that have lower data rates. While multiplexing the data streams provides a clear advantage, some challenges may remain and additional configurations may be required so as to provide additional desired functionality.

### BRIEF DESCRIPTION OF THE DRAWINGS

Illustrative embodiments by way of examples, not by way of limitation, are illustrated in the drawings. Throughout the description and drawings, similar reference numbers may be, but not necessarily, used to identify similar elements. The drawings are for illustrative purpose to assist understanding and may not be drawn per actual scale.

FIG. 1A illustrates a block diagram of a communication device;

FIG. 1B illustrates how the alignment pattern may be serialized and de-serialized;

FIG. 1C illustrates a block diagram of an alternative configuration of the pattern generator and the multiplexer;

FIG. 1D illustrates a block diagram of the fiber optic transceiver having the communication device shown in FIG. 1A;

FIG. 2A illustrates a block diagram of a communication apparatus;

FIGS. 2B-2C show illustrative views of a selector demultiplexing the serialized data stream;

FIG. 3A illustrates a block diagram of a communication device that is configured to transmit and receive a serialized data stream;

FIG. 3B illustrates an illustrative view of an output data stream;

FIG. 3C illustrates a state diagram of the communication device shown in FIG. 3A;

FIG. 4A illustrates a block diagram of a communication system;

FIG. 4B illustrates a state diagram for the communication system shown in FIG. 4A;

FIG. 4C illustrates an alternative state diagram for the communication system shown in FIG. 4A;

FIG. 4D illustrates how the first serial data stream may be formed;

FIG. 5 illustrates a communication device having a normal mode and an alignment mode;

FIG. 6A illustrates a method for lane alignment; and

FIGS. 6B-6D illustrate optional additional steps for the method shown in FIG. 6A.

### DETAILED DESCRIPTION

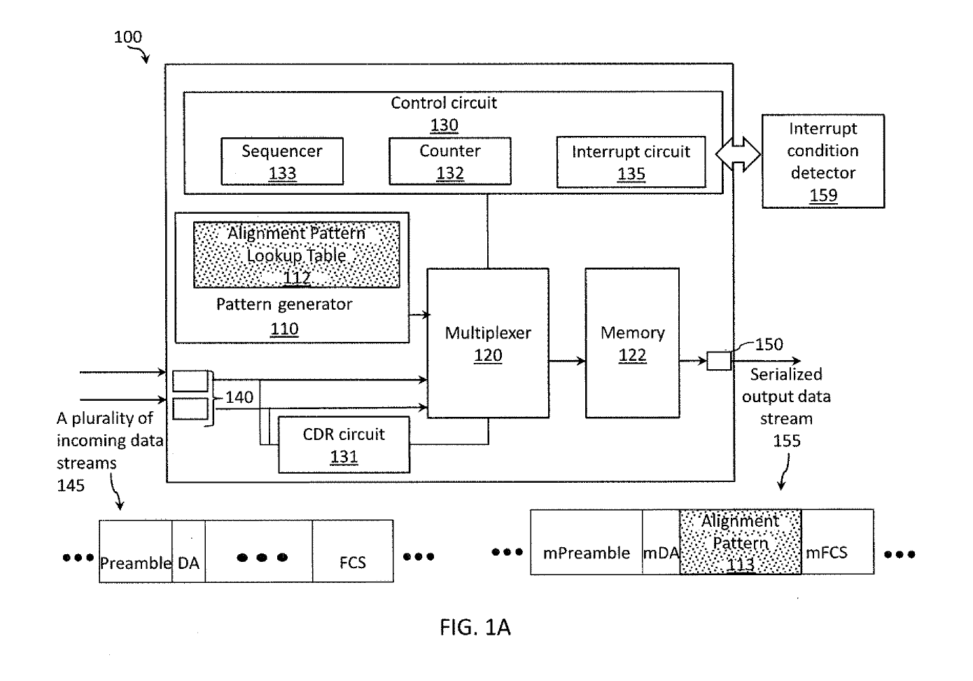

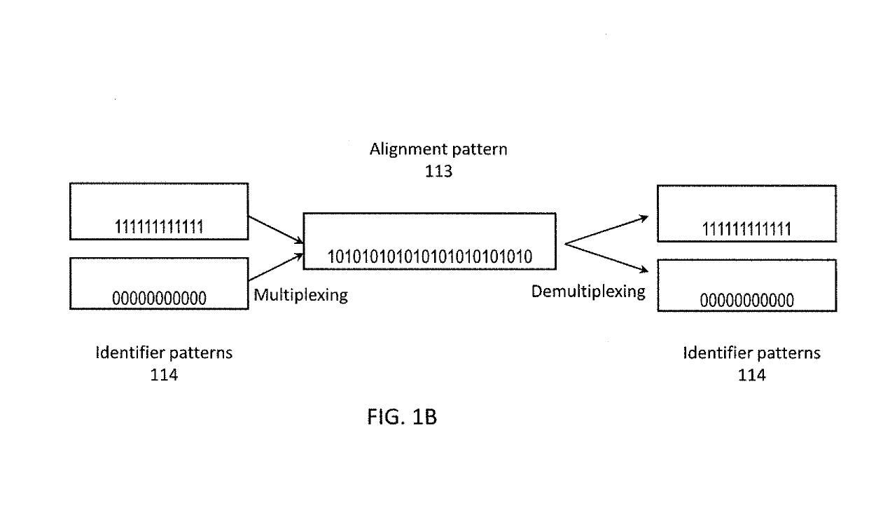

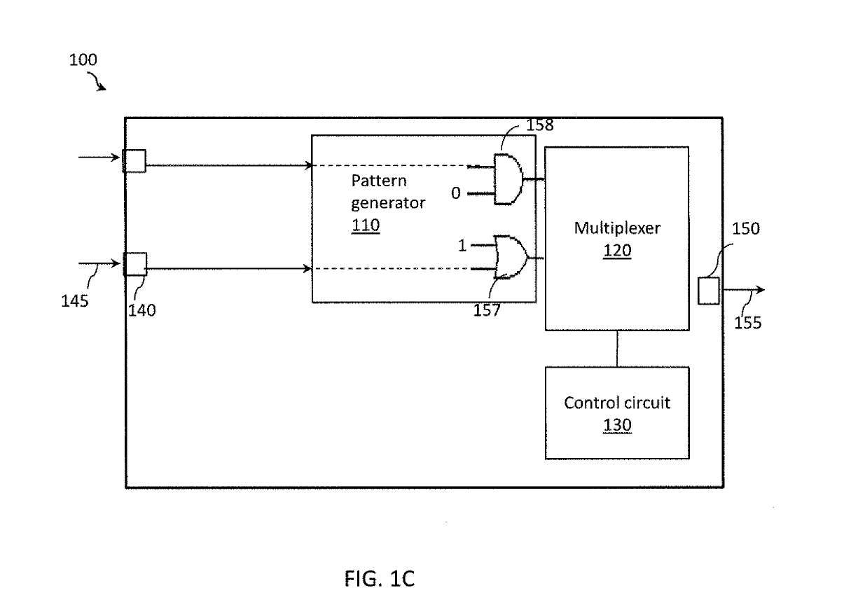

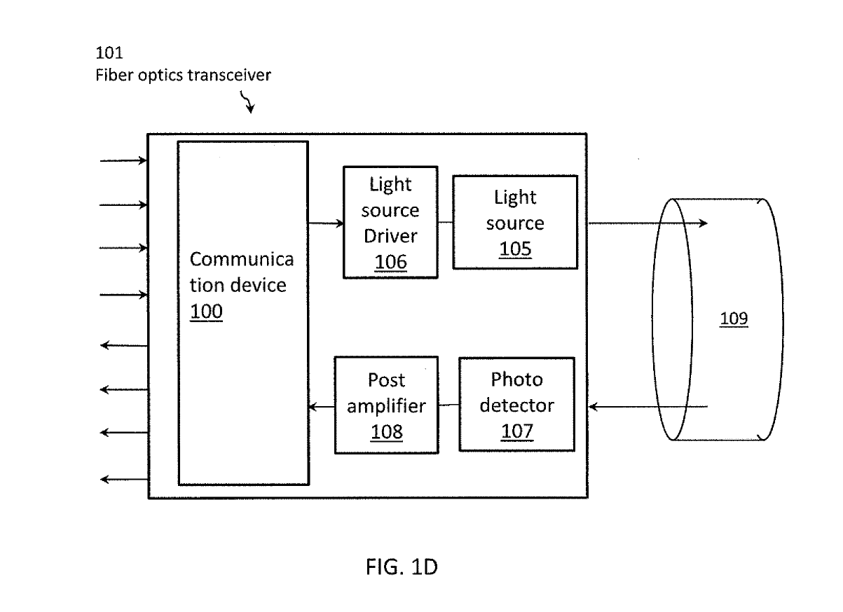

FIG. 1A illustrates a block diagram of a communication device 100 for performing data communication. The communication device 100 may comprise a plurality of inputs 140, a pattern generator 110, a multiplexer 120, and a control circuit 130. Optionally, the communication device may further comprise an alignment pattern look up table 112, a memory 122, a clock data recovery (referred hereinafter as “CDR”) circuit 131, a counter 132, a sequencer 133, and an interrupt circuit 135.

The plurality of inputs 140 may be configured to receive a plurality of incoming data streams 145. The plurality of incoming data streams 145 may be based on Ethernet networking protocol, Gigabit Ethernet, Fiber channel or any other networking protocol. The plurality of incoming data streams 145 may have a data rate of 125 Mb/s, 1 Gb/s, 10 Gb/s or any other data rates. The plurality of incoming data streams 145 may be encoded in 8B/10B encoding or 64B/66B or any other data encoding.

In one embodiment, the plurality of incoming data streams 145 may have a basic Ethernet frame structure which may comprise a data, a Preamble, a Start-of-Frame Delimiter (referred hereinafter as “SFD”), and headers such as a Destination Address (referred hereinafter as “DA”), and Source Address (referred hereinafter as “SA”). The plurality of incoming data streams 145 received at any one of the plurality of inputs 140 may be encoded to have an average duty cycle of approximately 50% as may be required by various communication standards.

The pattern generator 110 may be coupled with the plurality of inputs 140 and may be configured to generate an alignment pattern 113. In the embodiment shown in FIG. 1A, the alignment pattern 113 may be generated independently from the plurality of incoming data streams 145. More specifically, the pattern generator 110 may be configured to generate the alignment pattern 113 without performing bit by bit inspection on the plurality of incoming data streams 145 or without inserting or adding additional bits to the plurality of incoming data streams 145. In one embodiment, bit by bit inspection on the plurality of incoming data streams 145 may be substantially avoided. Similarly, insertion and/or addition of additional bits to the plurality of incoming data streams 145 may be substantially avoided. This arrangement may be advantageous for speeding up response time of the communication device 100. In another embodiment, the bit by bit inspection, bit insertion or deletion may be performed by the pattern generator 110 in accordance with the IEEE Standard for Ethernet, IEEE Std 802.3-2012 Section Four at pages 279-696, the content of which is herein incorporated by reference.

In one embodiment, the pattern generator 110 may be configured to generate the alignment pattern 113 with an average duty cycle of approximately 50%. This may be, but not necessary, required by various communication standards. While the alignment pattern 113 may be any combination of number, transmitting the alignment pattern without having 50% average duty cycle may add burden to the hardware design of the communication system (not shown) as the hardware may have to handle signal with extremely high or extremely low frequency. This burden may be substantially avoided if the average duty cycle of the alignment pattern 113 is approximately 50%.

FIG. 1B illustrates how the alignment pattern 113 may be generated using identifier patterns 114. The pattern generator 110 may be configured to retrieve the alignment pattern 113 and the identifier patterns 114 from the alignment pattern lookup table 112. As shown in FIG. 1B, the identifier patterns 114 may comprise first and second serial sequence patterns. During interruption, the interrupt circuit 135 coupled with the multiplexer 120 may be configured to control the multiplexer 120 to multiplex the first and second serial sequence patterns of the identifier patterns 114 into the serialized output data stream 155 in accordance with a predetermined order.

The identifier patterns 114 may be used to identify communication channels or also referred as lane identification. In the example shown in FIG. 1B, the bit values of one identifier pattern 114 may be all “1” with the average duty cycle of the alignment pattern 113 of approximately 100%. This may be significantly higher than the required average duty cycle of 50%. The other identifier pattern 114 shown in FIG. 1B may be all “0” with average duty cycle of approximately 0%. This may be significantly lower than the required average duty cycle of 50%. However, the identifier patterns 114 may be serialized to form the alignment pattern 113 having average duty cycle of 50%. In another communication device (not shown) where the alignment pattern 113 may be demultiplexed into the identifier patterns 114 that may be then employed to identify the communication channels.

As shown in FIG. 1A, the multiplexer 120 may be coupled with the plurality of inputs 140 and the pattern generator 110. The multiplexer 120 may comprise an output 150. The multiplexer 120 may be configured to multiplex the plurality of incoming data streams 145 to form a serialized output data stream 155 at the output 150. The control circuit 130 may be configured to control the multiplexer 120 such that the multiplexer 120 output bit by bit the plurality of incoming data streams 145 into the serialized output data stream 155 at a faster data rate. The serialized output data stream 155 may comprise mPreamble or mDA or mFCS which may be a mixture of bits of the Preamble or DA or FCS from the plurality of incoming data streams 145.

In another embodiment, the multiplexer 120 may comprise a Serializer Deserializer (referred hereinafter as “Serdes”) for serializing or deserializing the plurality of incoming data streams 145 or the serialized output data stream 155.

For example, the plurality of inputs 140 may comprise of two inputs. The plurality of incoming data streams 145 at each of the plurality of inputs 140 may have a data rate of 10 Gb/s. The multiplexer 120 may be configured to multiplex the plurality of incoming data streams 145 to form the serialized output data stream 155 with a data rate of 20 Gb/s. As illustrated above, the data rate of the serialized output data stream 155 may be approximately two times the data rate of the plurality of incoming data streams 145.

Similar to the pattern generator 110, the multiplexer 120 may be configured to multiplex the plurality of incoming data streams 145 and the alignment pattern 113 without inspecting the plurality of incoming data streams 145. The multiplexer 120 may be configured to ignore the plurality of incoming data streams 145 from at least one of the plurality of inputs 140 when multiplexing the alignment pattern 113 to the serialized output data stream 155. As a result, the speed of the communication device 100 in converting the plurality of incoming data streams 145 into the serialized output data stream 155 may be improved.

The control circuit 130 may be an integrated circuit, a microprocessor, a controller, a control logic, a state machine, a microcontroller and/or any other circuit that may be configured to control the multiplexer 120. The interrupt circuit 135, the counter 132, and the sequencer 133 may form a portion of the control circuit 130 but in another embodiment, the interrupt circuit 135, the counter 132, and the sequencer 133 may be formed separately outside the control circuit 130.

The interrupt circuit 135 may be configured to detect a signal from an interrupt condition detector 159. The interrupt condition detector 159 may be a portion of the communication device 100 or alternatively, the interrupt condition detector 159 may be a portion of an external circuit (not shown). The interrupt condition detector 159 may be a circuit for monitoring interrupt condition and the interrupt circuit 135 may be configured to generate an interrupt signal to trigger the multiplexer 120 to interrupt the plurality of incoming data streams 145 from at least one of the plurality of inputs 140 with the alignment pattern 113.

The interrupt condition may be triggered during the initial start up of the communication device 100. Alternatively, the interrupt condition may be triggered when an error flag is detected within the communication device 100, or within one external communication device (not shown) of the entire communication system (not shown). When the interrupt signal is detected, the control circuit 130 may be configured to control the multiplexer 120 to multiplex the alignment pattern 113 to the serialized output data stream 155 such that the plurality of incoming data streams 145 from at least one of the plurality of inputs 140 are interrupted.

The interrupt circuit 135 may be configured to interrupt the serialized output data stream 155 with the alignment pattern 113. As a result of the interruption, the output 150 may be configured to output the alignment pattern 113 in place of the serialized output data stream 155 when the serialized output data stream 155 is interrupted by the alignment pattern 113.

For example, in the embodiment shown in FIG. 1A where there are two inputs of the plurality of inputs 140, the multiplexer 120 may be configured to interrupt the plurality of incoming data streams 145 from all of the plurality of inputs 140. In another embodiment where the plurality of inputs 140 have more than two inputs, the multiplexer 120 may be configured to interrupt the plurality of incoming data streams 145 from at least two of the plurality of inputs 140, or a portion of the plurality of inputs 140, or all of the plurality of inputs 140.

The memory 122 may be optional. The memory 122 may be a random access memory (referred hereinafter as “RAM”), a buffer, a FIFO or any other circuits that may be configured to store electrical signals and/or state of electrical signals. As shown in FIG. 1A, the memory 122 may be coupled to the multiplexer 120. The memory 122 may be configured to store the serialized output data stream 155.

The interrupt circuit 135 may be configured to interrupt the serialized output data stream 155 in one or more of several different ways. For example, the interrupt circuit 135 may be configured to overwrite the memory 122 that stores the serialized output data stream 155 with the alignment pattern 113 when the interrupt circuit 135 is configured to interrupt the serialized output data stream 155 with the alignment pattern 113.

Alternatively or additionally, the interrupt circuit 135 may be configured to interrupt the plurality of incoming data streams 145 by way of multiplexing the alignment pattern 113 into the serialized output data stream 155 through the multiplexer 120. As shown in FIG. 1A, the multiplexer 120 may be coupled to the pattern generator 110 and the plurality of incoming data streams 145 as inputs. During the interruption, the plurality of incoming data streams 145 may be ignored and the output of the pattern generator 110 may be output to the memory 122.

FIG. 1C illustrates a block diagram of an alternative configuration of the multiplexer 120 and the pattern generator 110. In the block diagram shown in FIG. 1C, the plurality of incoming data streams 145 input from the plurality of inputs 140 may be coupled to the pattern generator 110. The pattern generator 110 may comprise at least an AND gate 158 and an OR gate 157 such that when the interrupt circuit 135 is configured to interrupt, the AND gate 158 and the OR gate 157 may be configured to output an alignment pattern 113 instead of the plurality of incoming data streams 145.

Referring back to FIG. 1A, the CDR circuit 131 may be configured to generate a clock signal and the counter 132 may be configured to count the clock signal. More specifically, the counter 132 may be configured to start counting the clock signal after the alignment pattern 113 is transmitted. The counter 132 may have a count value that may be indicative of a relative timing with reference to the timing when the alignment pattern 113 is transmitted. The control circuit 130 may be configured to trigger the multiplexer 120 to resume multiplexing the plurality of incoming data streams 145 after transmitting the alignment pattern 113. This may be done immediately after transmitting the alignment pattern 113, or after transmitting for a predetermined count of the counter 132, or after receiving an additional signal from an external communication device (not shown).

The control circuit 130 may be configured to control the multiplexer 120 to multiplex the plurality of incoming data streams 145 into the serialized output data stream 155 in accordance with a predetermined sequence. The predetermined sequence may be stored within the sequencer 133. In addition, the sequencer 133 may be configured to store a predetermined sequence of how the identifier patterns 114 shown in FIG. 1B is output.

FIG. 1D illustrates a block diagram of the fiber optic transceiver 101 having the communication device 100 shown in FIG. 1A. In other words, the communication device 100 shown in FIG. 1A may form a portion of the fiber optic transceiver 101. The fiber optic transceiver 101 may comprise the communication device 100, a light source driver 106 coupled to the communication device 100 and a light source 105 coupled to the light source driver 106 for transmitting data over an optical fiber 109. Optionally, the fiber optic transceiver 101 may comprise a photo detector 107 and a post amplifier 108 for receiving data over the optical fiber 109.

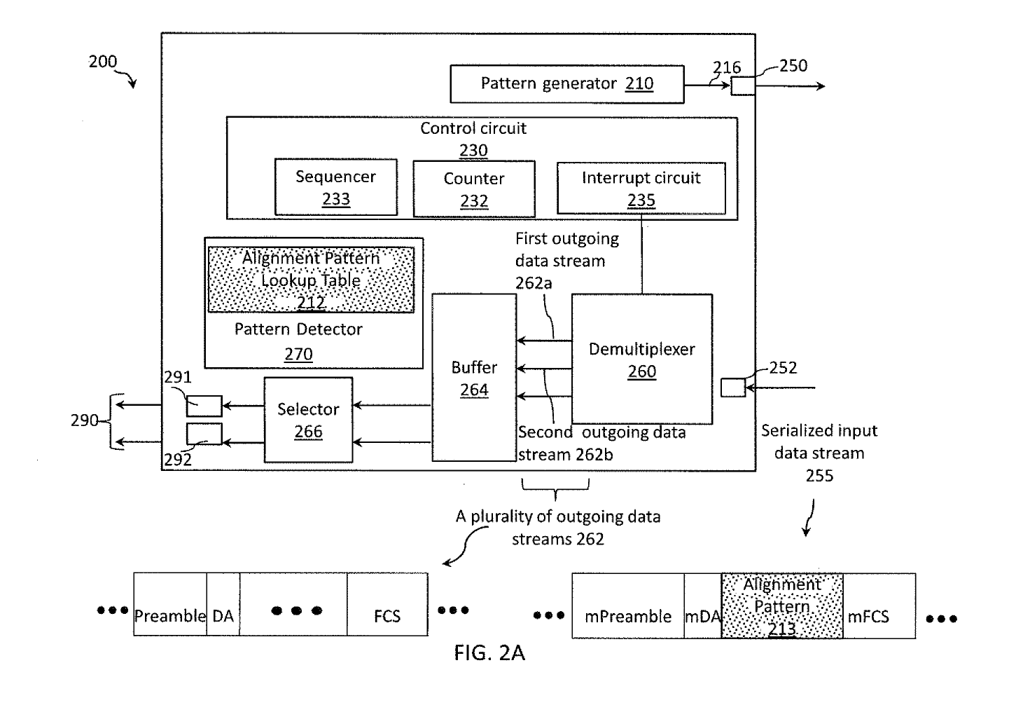

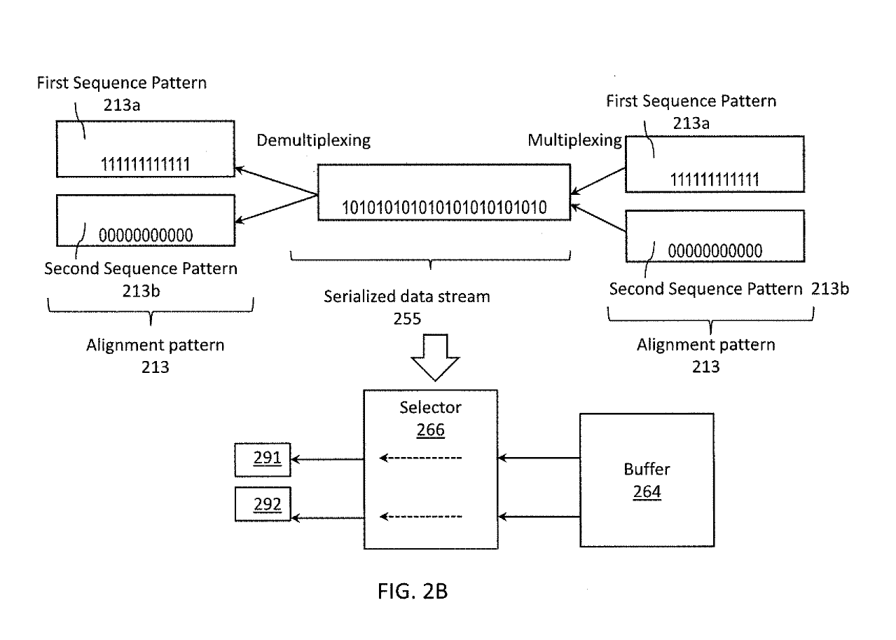

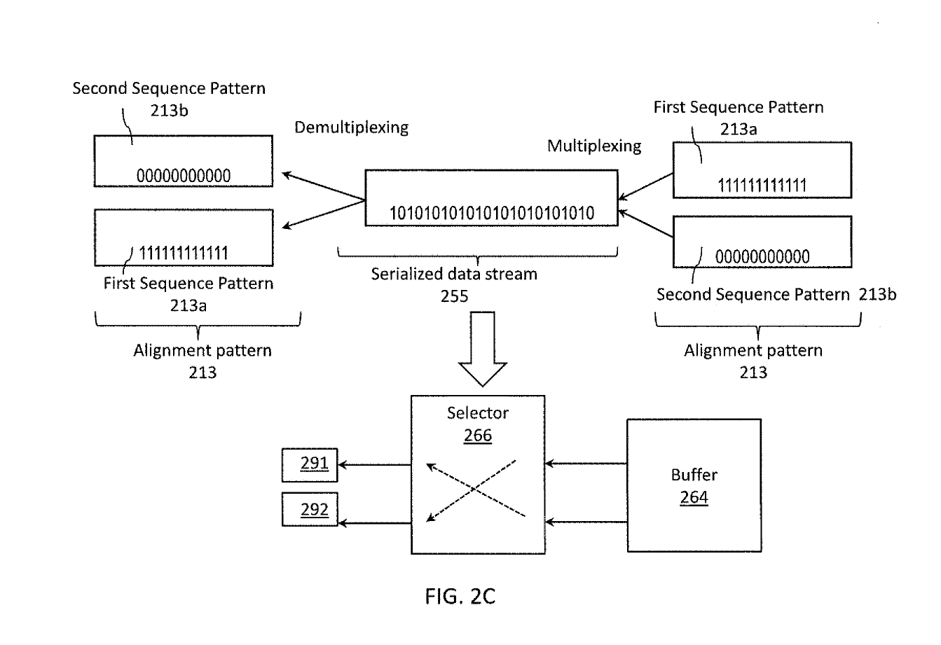

FIG. 2A illustrates a block diagram of a communication device 200 for data communication. The communication device 200 may be a receiver configured to receive the serialized output data stream 155 shown in FIG. 1A. As shown in FIG. 2A, the communication device 200 may comprise an input 252, a demultiplexer 260, a control circuit 230, a pattern detector 270, an interrupt circuit 235, a plurality of outputs 290. Optionally, the communication device 200 may further comprise an alignment pattern look up table 212, a buffer 264, a selector 266, a counter 232, and a sequencer 233.

The input 252 may be configured to receive a serialized input data stream 255 that may be similar to the serialized output data stream 155 shown in FIG. 1A. The demultiplexer 260 may be coupled with the input 252. The control circuit 230 may be configured to control the demultiplexer 260 to demultiplex the serialized input data stream 255 into a plurality of outgoing data streams 262 that may be output via the plurality of outputs 290. Each of the plurality of outgoing data streams 262 may be transmitted to an external host.

An example of one of the plurality of outgoing data streams 262 is shown at the bottom of FIG. 2A. Each of the plurality of the outgoing data streams 262 may comprise a data, a Preamble, a Start-of-Frame Delimiter (SFD), and headers such as a Destination Address (DA), and Source Address (SA). Similarly, the serialized input data stream 255 may comprise a data, a mPreamble, an MSFD, and headers such as a mDA, and mSA which are a mixture of the Preamble, SFD, DA or SA from the plurality of outgoing data streams 262 that are serialized together.

For example, the plurality of outgoing data streams 262 may comprise at least a first outgoing data stream 262a and a second outgoing data stream 262b. The plurality of outputs 290 may comprise a first output 291 and a second output 292. As shown in FIG. 2A, each of the first and second outgoing data streams may be output to host computers via the first and second outputs 291 and 292 respectively. The demultiplexer 260 may be configured to demultiplex the serialized input data stream 255 into the plurality of outgoing data streams 262 following a predetermined order determined by the sequencer 233 by demultiplexing the serialized input data stream 255 into the first outgoing data stream 262a before demultiplexing the serialized input data stream 255 into the second outgoing data stream 262b. The sequencer 233 may be configured to control the sequence of the demultiplexer 260 demultiplexing the serialized input data stream 255.

Optionally, the buffer 264 may be coupled to the demultiplexer 260 and may be configured to store the plurality of outgoing data streams 262. The selector 266 may be coupled between the buffer 264 and the plurality of outputs 290. In transmitting or receiving data, the selector 266 may be configured to interconnect the plurality of outgoing data streams 262 stored in the buffer 264 to the plurality of outputs 290 in accordance with a predetermined lane alignment sequence stored in the sequencer 233. The predetermined lane alignment sequence may refer to a sequence that is used by the communication device 200 to perform a lane alignment. In one embodiment, the lane alignment may refer to a process of deserializing the serialized input data stream 255 to a plurality of outgoing data streams 262 and reordering the plurality of outgoing data streams 262 according to the predetermined order. In another embodiment, the lane alignment may be performed by the demultiplexer 260 in accordance with the IEEE Standard for Ethernet, IEEE Std 802.3-2012 Section Four at pages 43-696, the content of which is herein incorporated by reference.

The pattern detector 270 may be coupled with the demultiplexer 260. The pattern detector 270 may be configured to detect an alignment pattern 213 from the plurality of outgoing data streams 262. The pattern detector 270 may be configured to compare the alignment pattern 213 with the alignment pattern lookup table 212. When the alignment pattern 213 is detected by the pattern detector 270, the interrupt circuit 235 of the control circuit 230 may be configured to interrupt the plurality of outgoing data streams 262.

The alignment pattern 213 may comprise a plurality of identifier patterns or a plurality of serial sequence patterns that are unique to each other. The demultiplexer 260 may be configured to demultiplex each of the plurality of serial sequence patterns into each of the plurality of outgoing data streams 262. The control circuit 230 may be configured to identify each of the plurality of outgoing data streams 262 by detecting each of the plurality of serial sequence patterns.

For example, as shown in FIG. 2B, a first sequence pattern 213a and a second sequence pattern 213b may be serialized into an alignment pattern 213. Alignment pattern 213 may be input to the communication device 200 as the serialized input data stream 255. The demultiplexer 260 may be configured to demultiplex the first and second sequence patterns 213a-213b into two different outgoing data streams 262 with each of them configured to be sent to different external host computers (not shown). In the example shown in FIG. 2B, the first and second sequence patterns 213a-213b may end up at the intended location of the plurality of outgoing data streams 262. The selector 266 may then be configured to output each of the plurality of outgoing data streams 262 to the respective first and second outputs 291-292.

However, due to mismatch of encoded timing or for some other reasons, it should be understood that an error may occur, and the first and second sequence patterns 213a-213b may be detected in a different location of the plurality outgoing data streams 262 as shown in FIG. 2C. In such case, the selector 266 may be configured to correct the connectivity by swapping the first and second outputs 291-292 accordingly so that the plurality of outgoing data steams 262 may still be transmitted to the respective host computers (not shown). As shown in FIG. 28 and FIG. 2C, the first and second sequence patterns 213a-213b may be employed as an identifier to label each of the communication channels and if an error in connectivity is detected, the selector 266 may be configured to reestablish the intended interconnection.

Optionally, the communication device 200 may comprise a pattern generator 210 coupled to a serial output 250 as shown in FIG. 2A. The pattern generator 210 may be configured to generate an acknowledgment pattern 216 when the alignment pattern 213 is detected. The acknowledgement pattern 216 may be output via the serial output 250. The acknowledgement pattern 216 may be transmitted to an external communication device (not shown) transmitting the serialized input data stream 255. The acknowledgement pattern 216 may share similar characteristics with the alignment pattern 213.

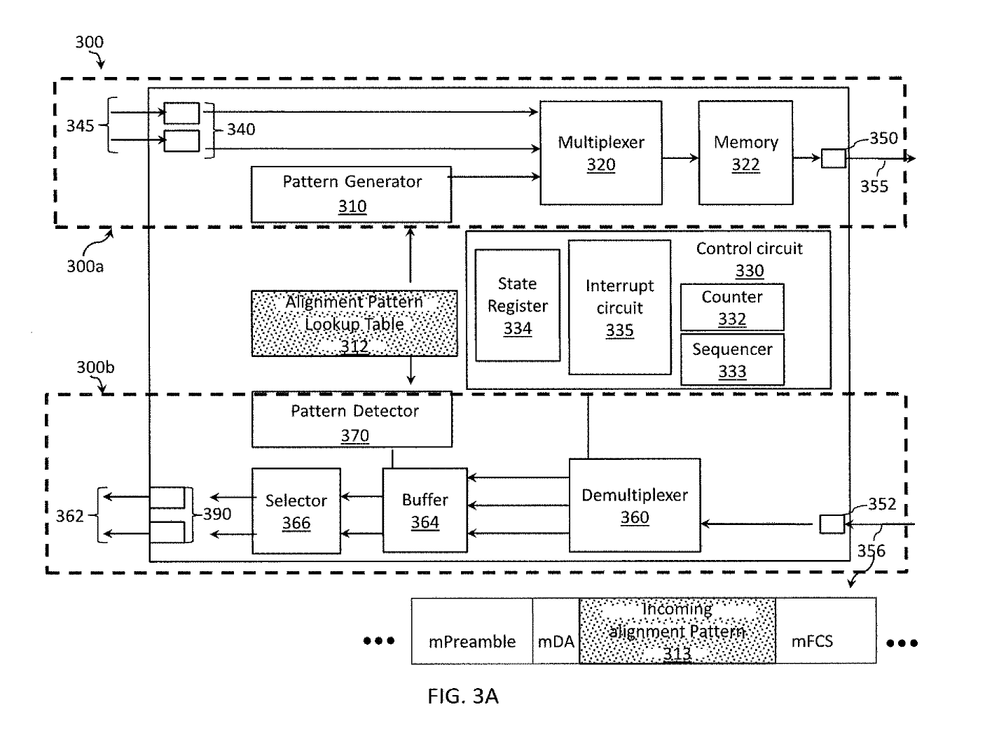

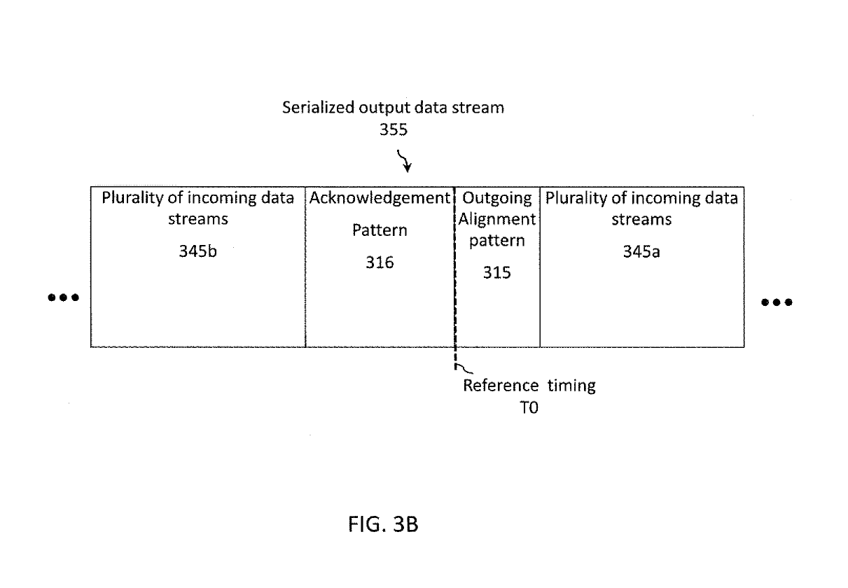

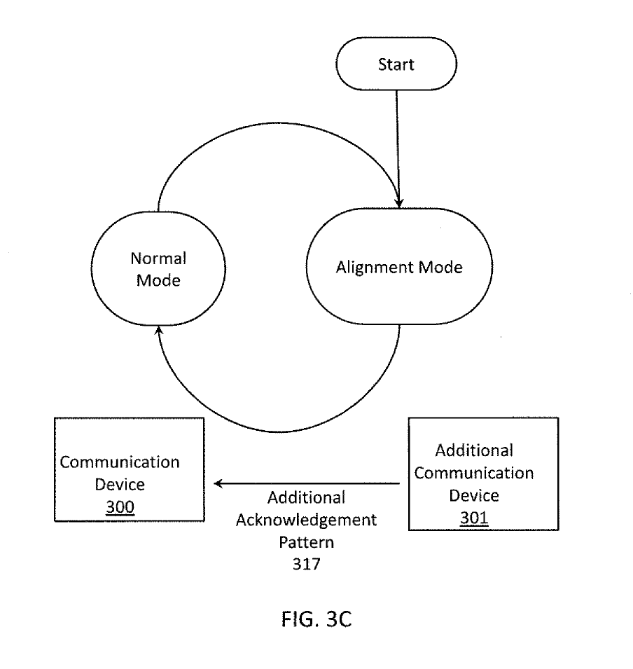

FIG. 3A illustrates a block diagram of a communication device 300 that may be configured to transmit and receive a serialized data stream. The communication device may be a transceiver which may comprise a transmitter 300a and a receiver 300b. The transmitter 300a may be configured to transmit a serialized output data stream 355, and the receiver 300b may be configured to receive the serialized input data stream 356.

The communication device 300 may comprise a plurality of inputs 340, a multiplexer 320, a memory 322, a pattern generator 310, an alignment pattern lookup table 312, a pattern detector 370, a control circuit 330, a serial output 350, a serial input 352, and a demultiplexer 360. The plurality of inputs 340, the multiplexer 320, the memory 322, and the pattern generator 310 may form a portion of the transmitter 300a. The demultiplexer 360, the serial input 352, the pattern detector 370 may form a portion of the receiver 300b.

The communication device 300 may also comprise an interrupt circuit 335, a counter 332, a sequencer 333, a state register 334, a buffer 364, and a selector 366. The plurality of inputs 340 may be configured to receive a plurality of incoming data streams 345. The plurality of incoming data streams 345 may have a basic Ethernet frame structure which comprises a data, a Preamble, a Start-of-Frame Delimiter (referred hereinafter as “SFD”), and headers such as a Destination Address (referred hereinafter as “DA”), and Source Address (referred hereinafter as “SA”). The plurality of incoming data streams 345 received at any one of the plurality of inputs 340 may be encoded to have an average duty cycle of approximately 50% as may be required by various communication standards

FIG. 3B illustrates an illustrative view of an output data stream. Referring now to FIGS. 3A and 3B, the pattern generator 310 may be configured to generate an outgoing alignment pattern 315. In the embodiment shown in FIG. 3A, the outgoing alignment pattern 315 may be generated independently from the plurality of incoming data streams 345. More specifically, the pattern generator 310 may be configured to generate the outgoing alignment pattern 315 without performing bit by bit inspection on the plurality of incoming data streams 345 or without inserting or adding additional bits to the plurality of incoming data streams 345. In other words, bit by bit inspection on the plurality of incoming data streams 345 may be substantially avoided. Similarly, insertion and/or addition of additional bits to the plurality of incoming data streams 345 may be substantially avoided. The pattern generator 310 may be configured to retrieve the outgoing alignment pattern 315 from the alignment pattern lookup table 312. The pattern generator 310 may be configured to generate an acknowledgement pattern 316 after interrupting the serialized output data stream 355 with the outgoing alignment pattern 315. In one embodiment, the acknowledgement pattern 316 may share some or all the characteristics of the alignment pattern in FIG. 1B.

The multiplexer 320 may be coupled with the plurality of inputs 340 and the pattern generator 310. The control circuit 330 may be configured to control the multiplexer 320 to multiplex the plurality of incoming data streams 345 into a serialized output data stream 355. In another embodiment, the multiplexer 320 may comprise a Serdes for serializing the plurality of incoming data streams 345.

The control circuit 330 may be an integrated circuit, a microprocessor, a controller, a control logic, a state machine, a microcontroller and/or any other circuit that may be configured to control the multiplexer 320. The interrupt circuit 335, the counter 332, and the sequencer 333 may form a portion of the control circuit 330 but in another embodiment, the interrupt circuit 335, the counter 332, and the sequencer 333 may be formed separately from the control circuit 330. The control circuit 330 may be configured to control the multiplexer 320 to multiplex the plurality of incoming data streams 345 into the serialized output data stream 355 in accordance with the predetermined sequence. The predetermined sequence may be stored within the sequencer 333.

The interrupt circuit 335 may be configured to interrupt the serialized output data stream 355 with the outgoing alignment pattern 315. The serial output 350 may be configured to output the outgoing alignment pattern 315 in place of the serialized output data stream 355, when the serialized output data stream 355 may be interrupted by the outgoing alignment pattern 315.

The memory 322 may be a RAM, a buffer, a FIFO or any other circuits that may be configured to store electrical signals and/or state of electrical signals. The memory 322 may be coupled to the multiplexer 320. The memory 322 may be configured to store the serialized output data stream 355.

The interrupt circuit 335 may be configured to interrupt the serialized output data stream 355 in one or more of several different ways. For example, the interrupt circuit 335 may be configured to overwrite the memory 322 that stores the serialized output data stream 355 with the outgoing alignment pattern 315 when the interrupt circuit 335 is configured to interrupt the serialized output data stream 355 with the outgoing alignment pattern 315.

Alternatively or additionally, the interrupt circuit 335 may be configured to interrupt the plurality of incoming data streams 345 by way of multiplexing the outgoing alignment pattern 315 into the serialized output data stream 355 through the multiplexer 320. The multiplexer 320 may be coupled to the pattern generator 310 and the plurality of inputs 340 as inputs. During the interruption, the plurality of incoming data streams 345 may be ignored and the output of the pattern generator 310 may be output to the memory 322.

The serial input 352 may be configured to receive a serialized input data stream 356. The demultiplexer 360 may be coupled with the serial input 352. The control circuit 330 may be configured to control the demultiplexer 360 to demultiplex the serialized input data stream 356 into a plurality of outgoing data streams 362 following a predetermined sequence. A plurality of outputs 390 may be configured to output the plurality of outgoing data streams 362. In one embodiment, the sequencer 333 may be configured to control the sequence of the demultiplexer 360 demultiplexing the serialized input data stream. In another embodiment, the demultiplexer 360 may be configured to perform deskewing in accordance with the IEEE Standard for Ethernet, IEEE Std 802.3-2012 Section Four at pages 310-696, the content of which is herein incorporated by reference.

Optionally, the buffer 364 may be coupled to the demultiplexer 360 and may be configured to store the plurality of outgoing data streams 362. In transmitting or receiving data, the selector 366 may be configured to interconnect the plurality of outgoing data streams 362 stored in the buffer 364 to the plurality of outputs 390 in accordance with a predetermined lane alignment sequence stored in the sequencer 333. The buffer 364 and the selector 366 may share some or all the characteristics of the buffer and the selector shown in FIG. 2A.

The pattern detector 370 may be coupled with the demultiplexer 360 and may be configured to detect an incoming alignment pattern 313 from the plurality of outgoing data streams 362. The pattern detector 370 may be configured to detect the incoming alignment pattern 313 by referring to the alignment pattern lookup table 312. In one embodiment, the pattern generator 310 may share the same alignment pattern lookup table 312 as the pattern detector 370. In another embodiment, the pattern generator 310 may share separate alignment pattern lookup table 312 from the pattern detector 370.

The transmitter 300a and the receiver 300b may share the same control circuit 330. The receiver 300b and the transmitter 300a may communicate to one another through the control circuit 330. For example, in one embodiment, the interrupt circuit 335 of the control circuit 330 may be configured to interrupt the serialized output data stream 355 and the plurality of incoming data streams 345 received at the plurality of inputs 340 when the incoming alignment pattern 313 is detected by the pattern detector 370. In another embodiment, when the pattern detector 370 of the receiver 300b detects the incoming alignment pattern 313, the control circuit 330 may be configured to control the multiplexer 320 of the transmitter 300a to interrupt the plurality of incoming data streams 345.

Referring to FIG. 3B, when there is an interruption in transmitting data stream, the serialized output data stream 355 sent by the communication device 300 may comprise the outgoing alignment pattern 315 and the acknowledgment pattern 316 in between the pluralities of incoming data streams 345a, 345b. The counter 332 may have a count value that may be indicative of a relative timing with reference to the timing when the outgoing alignment pattern 315 is transmitted. In one embodiment, the counter 332 may have a count value that may be indicative of a reference timing T0 that refers to the end of the outgoing alignment pattern 315. In another embodiment, the counter 332 may be configured to perform timing alignment. The counter 332 may be configured to perform timing alignment by using the count value to determine the start of the plurality of incoming data streams 345b from the reference timing T0.

Referring now to FIGS. 3A and 3C, the communication device 300 may form a portion of a communication system (not shown) and the communication system (not shown) may comprise an additional communication device 301. The state register 334 may be set in a normal mode or in the alignment mode. After the initial start up of the communication device 300, the state register 334 may be configured to be in the alignment mode. When the state register 334 is in the alignment mode, the pattern generator 310 may be configured to interrupt the plurality of incoming data streams 345 received at the plurality of inputs 340 with the outgoing alignment pattern 315.

The pattern detector 370 may be configured to detect an additional acknowledgement pattern 317. In one embodiment, the additional acknowledgement pattern 317 may share some or all the characteristics of the alignment pattern in FIG. 1B. The additional communication device 301 may be configured to generate the additional acknowledgement pattern 317.

The state register 334 may be set to the normal mode from the alignment mode when the additional acknowledgement pattern 317 from the additional communication device 301 is detected. When the state register 334 is in the normal mode, the plurality of incoming data streams 345 may be multiplexed to the serialized output data stream 355 and transmitted through the serial output 350. In the normal mode, the serialized output data stream 355 may be transmitted without the outgoing alignment pattern 315. In one embodiment, the serial output 350 may be configured to output the serialized output data stream 355 in place of the outgoing alignment pattern 315 after the additional acknowledgement pattern 317 from the additional communication device 301 is detected by the pattern detector 370.

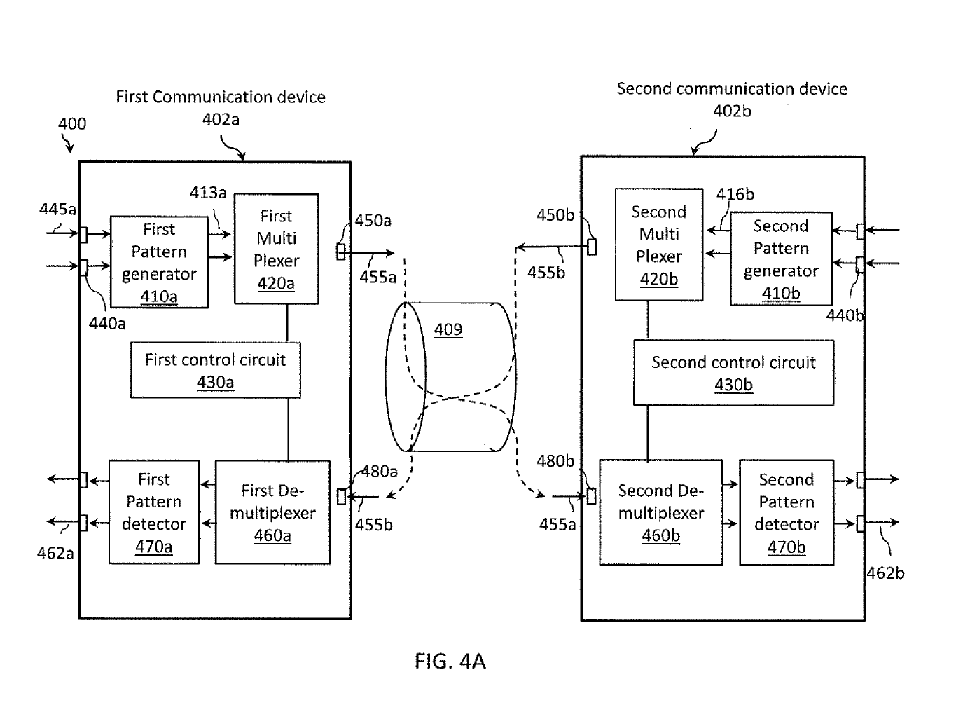

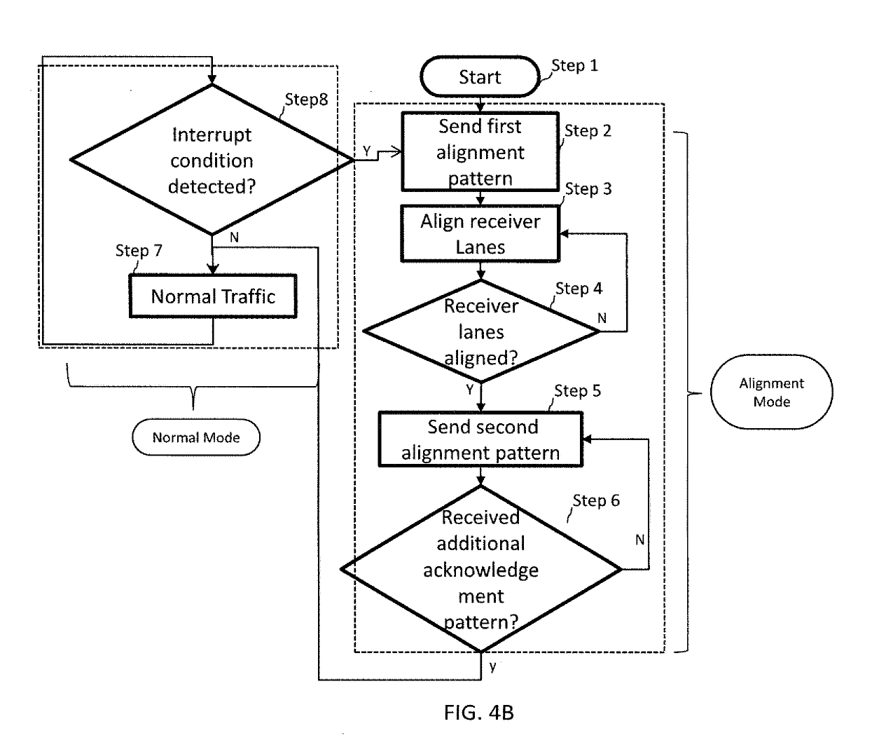

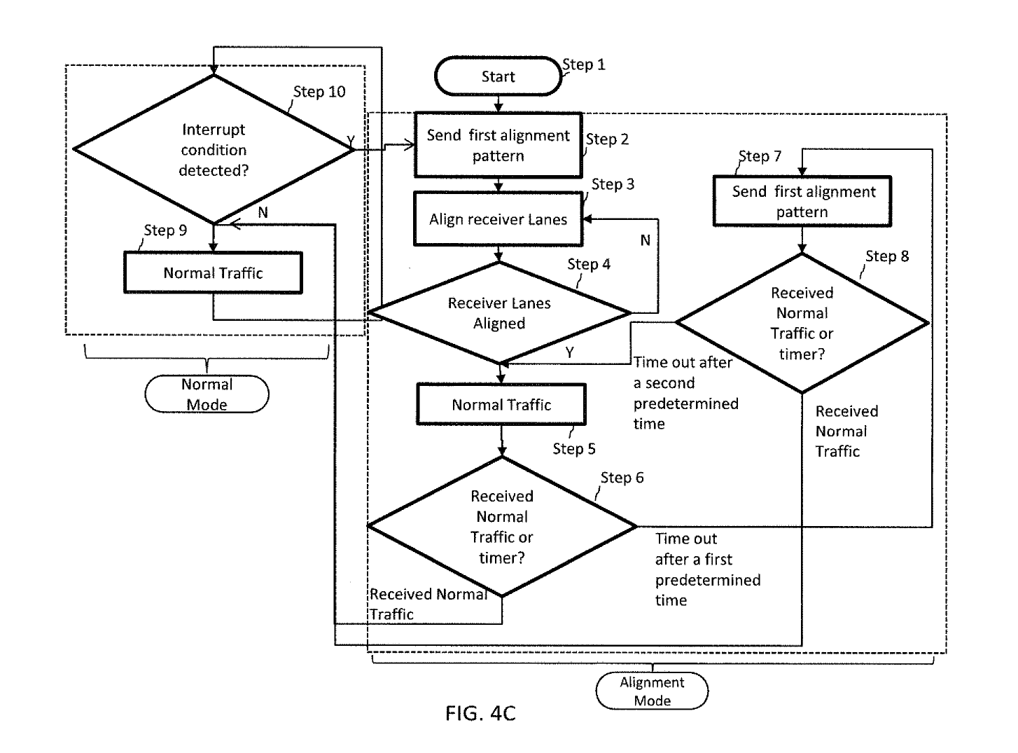

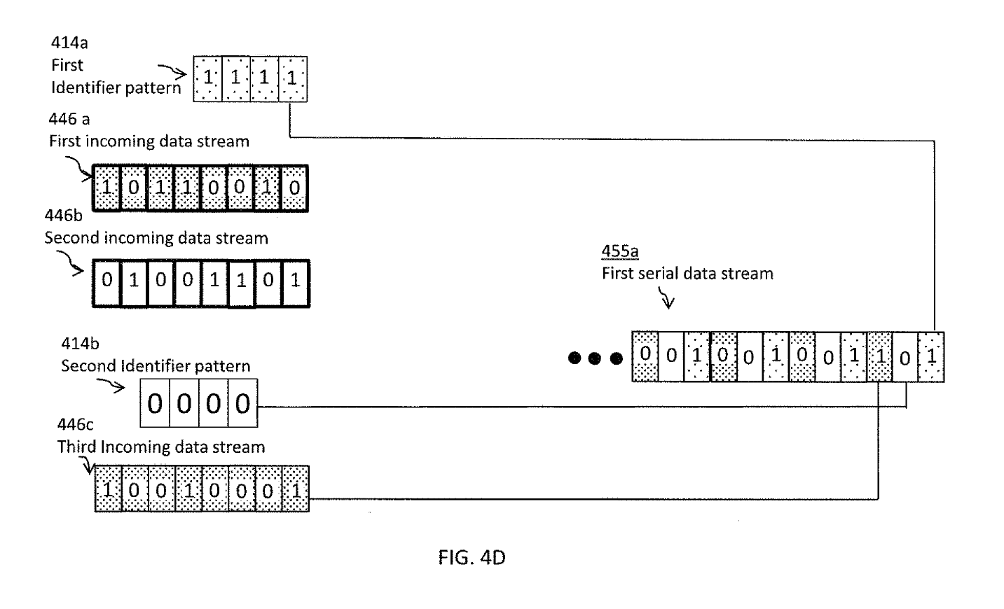

FIG. 4A illustrates a block diagram of a communication system 400. The communication system 400 may comprise a first communication device 402a and a second communication device 402b. The first communication device 402a may be configured to transmit and receive data stream with the second communication device 402b. The first communication device 402a may comprise a first multiplexer 420a, a first pattern generator 410a, a first control circuit 430a, a plurality of first inputs 440a, a first pattern detector 470a, a first receiver input 480a and a first demultiplexer 460a.

The first multiplexer 420a may be configured to multiplex a plurality of incoming data streams 445a received at the plurality of first inputs 440a into a first serial data stream 455a at a first output 450a. The first pattern generator 410a may be coupled with the first multiplexer 420a and may be configured to interrupt the plurality of incoming data streams 445a with a first alignment pattern 413a. The first alignment pattern 413a may share some or all of the characteristics of the alignment pattern 113 in FIG. 1

The second communication device 402b may comprise a second multiplexer 420b, a second pattern generator 410b, a second control circuit 430b, a second pattern detector 470b, a second demultiplexer 460b, a plurality of second inputs 440b, a second output 450b, and a second receiver input 480b. The second communication device 402b may be configured to receive the first serial data stream 455a. The first and second communication device 402a, 402b may have some or all of the characteristics of the communication device 300 shown in FIG. 3A.

The second pattern generator 410b may be configured to generate an acknowledgement pattern 416b to the first communication device 402a. The acknowledgement pattern 416b may be converted into a second serial data stream 455b when the second communication device 402b detects the first alignment pattern 413a from the first communication device 402a. The second demultiplexer 460b may be configured to demultiplex the first serial data stream 455a from the first communication device 402a into a plurality of second outgoing data streams 462b in accordance with a predetermined order.

FIG. 4B illustrates a state diagram for the communication system shown in FIG. 4A. The first control circuit 430a may be configured to generate an interrupt signal in response to an interrupt condition. The interrupt condition may be a condition during the initial start up of the first communication device 402a, which is indicated as start at Step 1. The first control circuit 430a may be configured to control the first multiplexer 420a to multiplex the first alignment pattern 413a to a first serial data stream 455a such that plurality of incoming data streams 445a from at least one of the plurality of first inputs 440a are interrupted in response to the interrupt signal. The first communication device 402a may be configured to transmit the first serial data stream 455a comprising the first alignment pattern 413a to the second communication device 402b as indicated in Step 2.

When the second pattern detector 470b detects the first alignment pattern 413a, the second control circuit 430b may be configured to control the second multiplexer 420b to multiplex an acknowledgement pattern 416b generated by the second pattern generator 410b. The second multiplexer 420b may be configured to multiplex the acknowledgement pattern 416b to the second serial data stream 455b. The second communication device 402b may be configured to transmit the second serial data stream 455b with the acknowledgement pattern 416b to the first communication device 402a. The first communication device 402a may be configured to align receiver lanes as indicated in Step 3. The first communication device 402a may be configured to align receiver lanes by using the first demultiplexer 460a to demultiplex the second serial data stream 455b into the plurality of first outgoing data streams 462a following a first predetermined order, which may be determined by the first control circuit 430a. The first control circuit 430a may be configured to detect if the receiver lanes are aligned as indicated in Step 4.

The first control circuit 430a may be configured to communicate to the first pattern generator 410a to generate a second alignment pattern after the second serial data stream 455b is demultiplexed into the plurality of first outgoing data streams 462a or after the receiver lanes are aligned. The second alignment pattern may share some or all of the characteristics of the alignment pattern 113 in FIG. 1. The first control circuit 430a may be configured to control the first multiplexer 420a to multiplex the second alignment pattern to the first serial data stream 455a replacing the first alignment pattern 413a while still interrupting the pluralities of incoming data streams 445a. The first communication device 402a may be configured to transmit the second alignment pattern to the second communication device 402b as indicated in Step 5.

The second demultiplexer 460b may be configured to demultiplex the first serial data stream 455a into the plurality of second outgoing data streams 462b following a second predetermined order, which may be determined by the second control circuit 430b. The second pattern generator 410b may be configured to generate an additional acknowledgement pattern after the second demultiplexer 460b demultipexes the first serial data stream 455a. The second communication device 402b may be configured to transmit the additional acknowledgement pattern to the first communication device 402a.

The first pattern detector 470a may be configured to detect the additional acknowledgement pattern from the second communication device 402b as indicated in Step 6. When the first communication device 402a receives the additional acknowledgement pattern from the second communication device 402b, the first communication device 402a may be configured to send a normal traffic to the second communication device 402b as indicated in Step 7. In one embodiment, the first communication device 402a may be configured to send the normal traffic by multiplexing the plurality of incoming data streams 445a into the first serial data stream 455a.

The first control circuit 430a may be configured to detect the interrupt condition as indicated in Step 8. The first communication device 402a may be configured to proceed to Step 2 after the interrupt condition is detected. The interrupt condition may be triggered when an error flag is detected within the first communication device 402a or at the second communication device 402b. The error flag may also be triggered when there is a loss of signal (LOS) or loss of lock (LOL) condition at the first communication device 402a or the second communication device 402b. The first communication device 402a may be in an alignment mode when performing steps 2-6. The first communication device 402a may be in a normal mode when performing steps 7-8.

FIG. 4C illustrates an alternative state diagram for the communication system shown in FIG. 4A. The first control circuit 430a may be configured to generate an interrupt signal in response to an interrupt condition. The interrupt condition may be a condition during the initial start up of the first communication device 402a, which is indicated as start at Step 1. The first control circuit 430a may be configured to control the first multiplexer 420a to multiplex a first alignment pattern 413a to a first serial data stream 455a such that plurality of incoming data streams 445a at the at least one of the plurality of first inputs 440a are interrupted in response to the interrupt signal. The first communication device 402a may be configured to transmit the first serial data stream 455a comprising the first alignment pattern 413a to the second communication device 402b as indicated in Step 2.

When the second pattern detector 470b detects the first alignment pattern 413a, the second control circuit 430b may be configured to control the second multiplexer 420b to multiplex an acknowledgement pattern 416b generated by the second pattern generator 410b. The second multiplexer 420b may be configured to multiplex the acknowledgement pattern 416b to a second serial data stream 455b. The second communication device 402b may be configured to transmit the second serial data stream 455b with the acknowledgement pattern 416b to the first communication device 402a.

The first communication device 402a may be configured to align receiver lanes as indicated in Step 3. The first communication device 402a may be configured to align receiver lanes by using the first demultiplexer 460a to demultiplex the second serial data stream 455b into the plurality of first outgoing data streams 462a following a predetermined order determined by the first control circuit 430a. The first control circuit 430a may be configured to detect if the receiver lanes are aligned as indicated in Step 4.

The first communication device 402a may be configured to send the normal traffic after the second serial data stream 455b is demultiplexed into the plurality of first outgoing data streams 462a or after the receiver lanes are aligned as indicated in Step 5. The first pattern detector 470a may be configured to detect whether a normal traffic is received from the second communication device 402b as indicated in Step 6. If the normal traffic is not detected by the first pattern detector 470a within a first predetermined time, the first communication device 402a may be configured to send the first alignment pattern 413a to the second communication device 402b as indicated in Step 7. The first pattern detector 470a may be configured to detect the normal traffic within a second predetermined time as indicated in Step 8. If the first pattern detector 470a does not detect the normal traffic within the second predetermined time, the first communication device 402a may be configured to send the normal traffic again as indicated in Step 5. In one embodiment, the first and second predetermined time may be at least longer than the time required for the first communication device 402a or the second communication device 402b to detect the first alignment pattern 413a. In another embodiment, the first and second predetermined time may be at least longer than the time required for the data stream to travel from the first communication device 402a to the second communication device 402b and from the second communication device 402b to the first communication device 402a.

If at Step 6 and Step 8 the normal traffic is detected by the first pattern detector 470a within the first or second predetermined time, the first communication device 402a may be configured to send the normal traffic as indicated in Step 9. The first control circuit 430a may be configured to detect the interrupt condition as indicated in Step 10. The first communication device 402a may be configured to proceed to Step 2 after the interrupt condition is detected. The interrupt condition may have some or all the characteristics of the interrupt condition in FIG. 4B. The first communication device 402a may be in an alignment mode when performing steps in Steps 2-8. The first communication device 402a may be in a normal mode when performing steps in Steps 9-10.

FIG. 4D illustrates how the first serial data stream 455a is formed. The plurality of incoming data streams 445a may comprise a first data stream 446a, a second data stream 446b and a third data stream 446c. The alignment pattern 413a may comprise first and second identifier patterns 414a, 414b. The first pattern generator 410a may be configured to interrupt the first data stream with the first identifier pattern 414a. The first pattern generator 410a may be configured to interrupt the second data stream with the second identifier pattern 414b. The first multiplexer 420a may be configured to multiplex bit by bit the first and second identifier patterns 414a, 414b and the third data stream 446c to form the first serial data stream 455a. As a result, the first serial data stream 455a may comprise the first and second identifier patterns 414a, 414b and the third data stream 446c arranged in a predetermined order. The first and second identifier patterns 414a, 414b may share some or all the characteristics of the identifier patterns 114 shown in FIG. 1B.

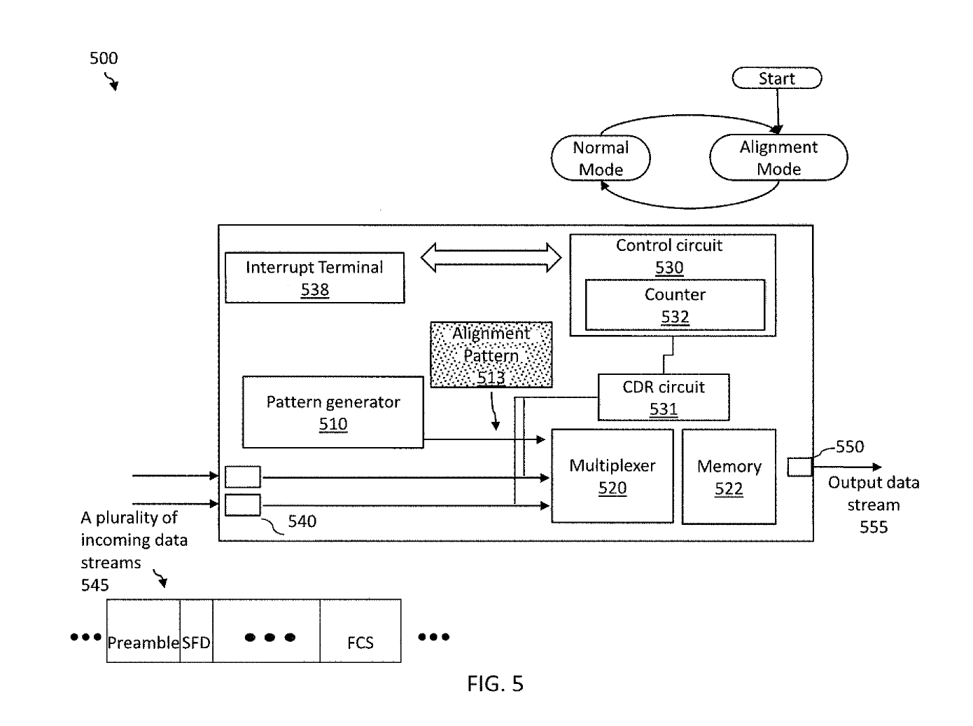

FIG. 5 illustrates a communication device 500 having first and second operative modes, e.g. a normal mode and an alignment mode. The communication device 500 may comprise a plurality of inputs 540, a pattern generator 510, a multiplexer 520, an interrupt terminal 538, a control circuit 530, and an output 550. The communication device 500 may share some or all of the characteristics of the communication device 100 shown in FIG. 1A. The plurality of inputs 540 may be configured to receive a plurality of incoming data streams 545. In one embodiment, the plurality of incoming data streams 545 may have a basic Ethernet frame structure which comprises a data, a Preamble, a Start-of-Frame Delimiter (referred hereinafter as “SFD”), and headers such as a Destination Address (referred hereinafter as “DA”), and Source Address (referred hereinafter as “SA”). The plurality of incoming data streams 545 received at any one of the plurality of inputs 540 may be encoded to have an average duty cycle of approximately 50% as may be required by various communication standards.

The pattern generator 510 may be configured to generate an alignment pattern 513. In the embodiment shown in FIG. 5, the alignment pattern 513 may be generated independently from the plurality of incoming data streams 545. More specifically, the pattern generator 510 may be configured to generate the alignment pattern 513 without performing bit by bit inspection on the plurality of incoming data streams 545 or without inserting or adding additional bits to the plurality of incoming data streams 545. The multiplexer 520 may be coupled with the pattern generator 510 and the plurality of inputs 540. The multiplexer 520 may have some or all the characteristics of the multiplexer described in FIG. 1A. The output 550 may be coupled to the multiplexer 520.

The control circuit 530 may be coupled to the multiplexer 520. The control circuit 530 may be configured to control the multiplexer 520 so as to serialize all of the plurality of incoming data streams 545 into a serial output data stream 555 during a normal mode. The interrupt terminal 538 may be configured to receive an interrupt signal. The control circuit 530 may be configured to interrupt at least one of the plurality of incoming data streams 545 when the interrupt signal is received during an alignment mode. The control circuit 530 may comprise a counter 532. The communication device 500 may further comprise a CDR circuit. The CDR circuit 531 may be coupled with the counter 532 to generate a clock signal. The counter 532 may be configured to start counting the clock signal when the control circuit 530 may be set to the normal mode from the alignment mode.

The communication device 500 may further comprise a memory 522. The memory 522 may be configured to store the serial output data stream 555. The control circuit 530 may be configured to overwrite the at least one of the plurality of the incoming data streams 545 in the memory 522 with the alignment pattern 513 during the alignment mode.

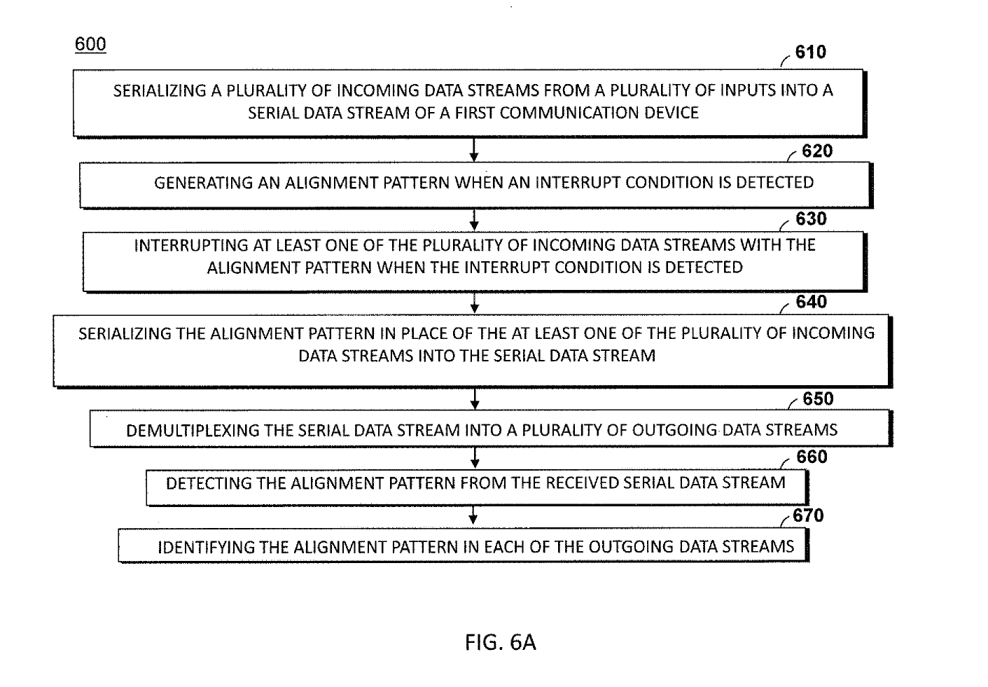

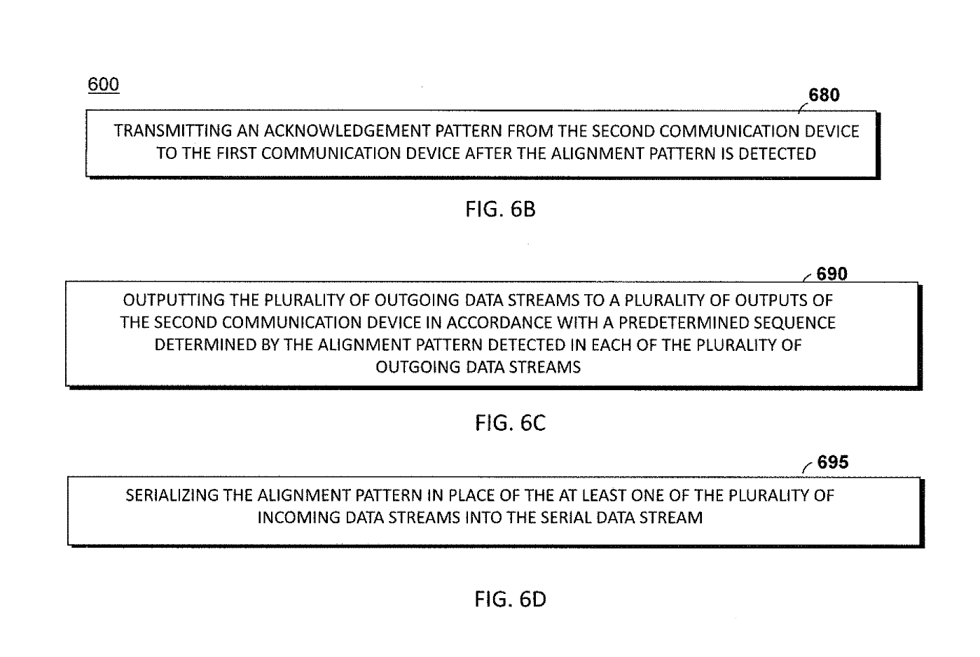

FIG. 6A illustrates a method for lane alignment. The method for lane alignment may comprise serializing a plurality of incoming data streams from a plurality of inputs into a serial data stream of a first communication device as shown in Step 610. The first communication device may be configured to generate an alignment pattern when an interrupt condition is detected as shown in Step 620. The first communication device may be configured to interrupt at least one of the plurality of incoming data streams with the alignment pattern when the interrupt condition is detected as shown in Step 630. In Step 640, the first communication device may be configured to serialize the alignment pattern in place of the at least one of the plurality of incoming data streams into the serial data stream. The first communication device may be configured to transmit the serial data stream to a second communication device.

In step 650, the second communication device may be configured to demultiplex the serial data stream into a plurality of outgoing data streams. In step 660, the second communication device may be configured to detect the alignment pattern from the serial data stream received at the second communication device. In step 670, the second communication device may be configured to identify the alignment pattern in each of the plurality of outgoing data streams.

FIGS. 6B-6D illustrate optional additional steps for the method shown in FIG. 6A. In step 680, the second communication device may be configured to transmit an acknowledgement pattern to the first communication device after the alignment pattern is detected. In step 690, the second communication device may be configured to output the plurality of outgoing data streams to a plurality of outputs of the second communication device in accordance with a predetermined sequence determined by the alignment pattern detected in each of the plurality of outgoing data streams. In step 695, the first communication may be configured to serialize the alignment pattern in place of the at least one of the plurality of incoming data streams into the serial data stream.

Different aspects, embodiments or implementations may, but need not, yield one or more of the advantages. For example, the pattern generator may be configured to generate the alignment pattern with the average duty cycle of approximately 50%, which may prevent or substantially avoid adding burden to the hardware design of the communication system in handling data stream with extremely high frequency. Likewise, the interrupt circuit may be configured to control the multiplexer to multiplex the first and second serial sequence patterns of the identifier patterns into the serialized output data stream in accordance with a predetermined order. The predetermined order may be useful in aiding the demultiplexer, receiving the serialized output data stream to demultiplex the serialized output data stream in a sequence following the predetermined order.

Although specific embodiments of the invention have been described and illustrated herein above, the invention should not be limited to any specific forms or arrangements of parts so described and illustrated. For example, the multiplexer or demultiplexer described above may be a serializer deserializer or some other future multiplexer or demultiplexer as known or later developed without departing from the spirit of the invention. Likewise, the normal and alignment mode described in the embodiments in FIGS. 3, 4 and 5 may be applicable to the embodiments in FIGS. 1 and 2 as well. Similarly, the embodiments described herein may be configured to perform in accordance with the IEEE Standard for Ethernet, IEEE Std 802.3-2012 Section Four at pages 37-696, the content of which is herein incorporated by reference. The scope of the invention is to be defined by the claims.

What is claimed is:

1. A communication device, comprising:
a plurality of inputs configured to receive a plurality of incoming data streams;
a pattern generator configured to generate an alignment pattern;
a multiplexer coupled with the plurality of inputs and the pattern generator;
a control circuit configured to control the multiplexer to multiplex the plurality of incoming data streams into a serialized output data stream;
an interrupt circuit configured to interrupt the serialized output data stream with the alignment pattern; and
an output configured to output the alignment pattern in place of the serialized output data stream, when the serialized output data stream is interrupted by the alignment pattern.

2. The communication device of claim 1 further comprising a memory coupled to the multiplexer configured to store the serialized output data stream.

3. The communication device of claim 2, wherein the interrupt circuit is configured to overwrite the memory that stores the serialized output data stream with the alignment pattern, when the interrupt circuit is configured to interrupt the serialized output data stream with the alignment pattern.

4. The communication device of claim 1, wherein the interrupt circuit is configured to interrupt the plurality of incoming data streams by way of multiplexing the alignment pattern into the serialized output data stream through the multiplexer.

5. The communication device of claim 1, wherein:
the interrupt circuit is coupled to the multiplexer;
the pattern generator is configured to generate first and second serial sequence patterns; and
the interrupt circuit is configured to control the multiplexer to multiplex the first and second serial sequence patterns into the serialized output data stream in accordance with a predetermined order.

6. The communication device of claim 1 further comprising:
a counter coupled with the control circuit; and
a clock data recovery circuit configured to generate a clock signal, wherein the counter is configured to start counting the clock signal after the alignment pattern is transmitted.

7. The communication device of claim 6, wherein the control circuit is configured to trigger the multiplexer to resume multiplexing the plurality of incoming data streams after transmitting the alignment pattern for a predetermined count of the counter.

8. The communication device of claim 1 further comprising a sequencer configured to store a predetermined sequence, wherein the control circuit is configured to control the multiplexer to multiplex the plurality of incoming data streams into the serialized output data stream in accordance with the predetermined sequence.

9. The communication device of claim 1 forms a portion of a fiber optic transceiver.

10. A communication apparatus, comprising:
an input configured to receive a serialized input data stream;
a demultiplexer coupled with the input;
a control circuit configured to control the demultiplexer to demultiplex the serialized input data stream into a plurality of outgoing data streams;
a plurality of outputs configured to output the plurality of outgoing data streams;
a pattern detector coupled with the demultiplexer configured to detect an alignment pattern from the plurality of outgoing data streams; and
an interrupt circuit of the control circuit configured to interrupt the plurality of outgoing data streams when the alignment pattern is detected by the pattern detector.

11. The communication apparatus of claim 10, wherein the plurality of outgoing data streams comprises at least a first outgoing data stream and a second outgoing data stream, wherein the demultiplexer is configured to demultiplex the serialized input data stream into the plurality of outgoing data streams following a predetermined order by demultiplexing the serialized input data stream into the first outgoing data stream before demultiplexing the serialized input data stream into the second outgoing data stream.

12. The communication apparatus of claim 10 further comprising a sequencer configured to control sequence of the demultiplexer demultiplexing the serialized input data stream.

13. The communication apparatus of claim 10 further comprising a buffer configured to store the plurality of outgoing data streams.

14. The communication apparatus of claim 13 further comprising a selector coupled between the buffer and the plurality of outputs.

15. The communication apparatus of claim 14, wherein the selector is configured to interconnect the plurality of outgoing data streams stored in the buffer to the plurality of outputs in accordance with a predetermined lane alignment sequence.

16. The communication apparatus of claim 10 further comprising a pattern generator, wherein the pattern generator is configured to generate an acknowledgment pattern when the alignment pattern is detected.

17. A communication device, comprising:
a plurality of inputs configured to receive a plurality of incoming data streams;
a pattern generator configured to generate an outgoing alignment pattern;
a multiplexer coupled with the plurality of inputs and the pattern generator;
a control circuit configured to control the multiplexer to multiplex the plurality of incoming data streams into a serialized output data stream;
an interrupt circuit configured to interrupt the serialized output data stream with the outgoing alignment pattern;
a serial output configured to output the outgoing alignment pattern in place of the output data stream, when the serialized output data stream is interrupted by the outgoing alignment pattern;
a serial input configured to receive a serialized input data stream;
a demultiplexer coupled with the serial input, wherein the control circuit configured to control the demultiplexer to demultiplex the serialized input data stream into a plurality of outgoing data streams following a predetermined sequence; and
a plurality of outputs configured to output the plurality of outgoing data streams.

18. The communication device of claim 17 further comprising a pattern detector coupled with the demultiplexer configured to detect an incoming alignment pattern from the plurality of outgoing data streams.

19. The communication device of claim 18, wherein the interrupt circuit of the control circuit is configured to interrupt the serialized output data stream and the plurality of incoming data streams when the incoming alignment pattern is detected by the pattern detector.

20. The communication device of claim 17 further comprising a state register coupled with the control circuit, wherein:
the control circuit is configured to set the state register to a normal mode when the serialized output data stream is transmitted to the serial output; and
the control circuit is configured to set the state register to an alignment mode when the serialized output data stream is interrupted.
